(19) United States
(12) Patent Application Publication
(10) Pub. No.: US 2019/0381915 A1
(43) Pub. Date: Dec. 19, 2019

(54) POWER SEAT SLIDE DEVICE

(71) Applicant: SHIROKI CORPORATION, Fujisawa-shi, Kanagawa (JP)

(72) Inventors: Mitsugu Taniguchi, Kanagawa (JP); Yuta Murakami, Nagoya-shi, Aichi-ken (JP)

(73) Assignee: SHIROKI CORPORATION, Fujisawa-shi, Kanagawa (JP)

(21) Appl. No.: 16/463,881

(22) PCT Filed: Nov. 6, 2017
(86) PCT No.: PCT/JP2017/039952

§ 371 Date: May 24, 2019

(30) Foreign Application Priority Data
Nov. 28, 2016 (JP) 2016-230587

(51) Int. Cl. B60N 2/06; B60N 2/07

(52) U.S. Cl. CPC B60N 2/067; B60N 2/0705

(57) ABSTRACT

A power seat slide device includes, for example, a nut member fixed to one of a floor and a seat in a vehicle; a rod screw member that is placed on the other of the floor and the seat in a lengthwise direction of the vehicle, and is to be screwed into the nut member; a screw-through member that is fixed to the other of the floor and the seat, and provided with a through hole through which the rod screw member rotatably passes; a screw fixing member fixed to part of the rod screw member in an axial direction; and a plurality of roll members arranged around the rod screw member in a circumferential direction, to come into sliding contact with the screw-through member and the screw fixing member in the axial direction.

### CROSS-REFERENCE TO RELATED APPLICATIONS

This application is a national stage application of International Application No. PCT/JP2017/039952, filed Nov. 6, 2017, which designates the United States, incorporated herein by reference, and which claims the benefit of priority from Japanese Patent Application No. 2016-230587, filed Nov. 28, 2016, the entire contents of which are incorporated herein by reference.

### TECHNICAL FIELD

The present invention relates generally to a power seat slide device.

### BACKGROUND ART

Conventionally, power seat slide devices that use the power of a motor for moving and adjusting the position of a seat in a vehicle in a lengthwise direction of the vehicle are known. Such a power seat slide device includes, for example, a motor on an upper rail to which a seat is fixed, and a rod screw member to be rotated by the motor, and a nut member fixed to a lower rail on a floor, into which the rod screw member is screwed. The upper rail is slid with respect to the lower rail, thereby moving the seat. The power seat slide device includes a load transmission mechanism that transmits, to the axis of the rod screw member, a load applied to the upper rail from the seat, to thereby avoid applying a large load to a gearbox or the motor that rotates the rod screw member (for example, disclosed in Japanese Laid-open Patent Application Publication No. 2000-85420).

However, the load transmission mechanism of the conventional power seat slide device includes a bracket in contact with the key groove or the projection of the rod screw member having as a rotational load transmission part. Thus, the bracket and the rod screw member may not smoothly slide with each other. For example, due to assembly error in the rod screw member or the nut member or dimensional variations in respective members (components), the rod screw member may be undulated during rotation. If the rod screw member and the bracket do not smoothly slide with each other, the undulation of the rod screw member may cause variation in rotational resistance, and the rotation speed of the rod screw member may become inconstant. This may result in hindering the seat from smoothly sliding (moving) or occurrence of unusual noise or vibration.

An object of the present invention is, for example, to provide a power seat slide device including a sliding part that smoothly slides for load transmission to allow the rotation of a rod screw member to be constant, so as not to generate vibration or unusual noise during sliding of the seat.

### SUMMARY

According to one embodiment of the present invention, a power seat slide device includes a nut member fixed to one of a floor and a seat in a vehicle; a rod screw member that is placed on the other of the floor and the seat in a lengthwise direction of the vehicle, the rod screw member to be screwed into the nut member; a screw-through member that is fixed to the other of the floor and the seat, and provided with a through hole through which the rod screw member rotatably passes; a screw fixing member fixed to part of the rod screw member in an axial direction; and a plurality of roll members arranged around the rod screw member in a circumferential direction, to come into sliding contact with the screw-through member and the screw fixing member in the axial direction.

In the power seat slide device according to one embodiment of the present invention, for example, the roll members may be supported by a guide member. The guide member is placed between the screw-through member and the screw fixing member in the lengthwise direction and rotatable relative to at least one of the screw-through member and the screw fixing member.

In the power seat slide device according to one embodiment of the present invention, for example, the guide member may include a holder that maintains an interval between the roll members in the circumferential direction.

In the power seat slide device according to one embodiment of the present invention, for example, the screw-through member may include a concave surface serving as a sliding contact surface to come into sliding contact with the rolling members, the concave surface that is recessed in the axial direction toward a rotation center of the rod screw member.

In the power seat slide device according to one embodiment of the present invention, for example, the rolling members are spheres, and the screw-through member may include a convex surface serving as a sliding contact surface to come into sliding contact with the spheres, the convex surface that protrudes in the axial direction toward a rotation center of the rod screw member.

In the power seat slide device according to one embodiment of the present invention, for example, the rolling members are spheres; and the screw-through member may include a concave surface serving as a sliding contact surface to come into sliding contact with the spheres, the concave surface that is recessed in the axial direction toward a rotation center of the rod screw member; and the concave surface may be smaller in curvature than the spheres.

In the power seat slide device according to one embodiment of the present invention, for example, the number of the roll members may be at least three or more.

In the power seat slide device, the screw-through member comes into sliding contact with the screw fixing member via the rolling members, to easily change the relative position between the screw-through member and the screw fixing member irrespective of undulation of the rod screw member during rotation. This results in abating rotational resistance to the rod screw member in rotation to allow the rod screw member to stably rotate, preventing occurrence of vibration or unusual noise at the time when the seat is slid.

### BRIEF DESCRIPTION OF DRAWINGS

FIG. 1 is a perspective view of a vehicle seat on which a power seat slide device according to an embodiment is installed;

FIG. 2 is a schematic cross-sectional view illustrating the overall structure of a power seat slide device including a load transmission mechanism according to a first embodiment;

FIG. 3 is an exploded perspective view of the load transmission mechanism of the power seat slide device in FIG. 2;

FIG. 4 is a cross-sectional view illustrating details of the load transmission mechanism illustrated in FIG. 3, and a relation between a curved surface shape of a screw-through member and the center of undulation of the rod screw member;

FIG. 5 is a cross-sectional view illustrating details of a modification of the screw-through member and a relationship between the curved surface shape of the screw-through member and the center of undulation of the rod screw member;

FIG. 6 is a perspective view illustrating a modification of a rolling member and a guide member;

FIG. 7 is an exploded perspective view of a load transmission mechanism of a power seat slide device according to a second embodiment;

FIG. 8 is a cross-sectional view of details of the load transmission mechanism according to the second embodiment illustrated in FIG. 7;

FIG. 9 is an exploded perspective view of a load transmission mechanism of a power seat slide device according to a third embodiment; and

FIG. 10 is a cross-sectional view of details of the load transmission mechanism according to the third embodiment illustrated in FIG. 9.

### DESCRIPTION OF EMBODIMENTS

The following discloses exemplary embodiments of the present invention. Features of the embodiments described below and functions and results (effects) attained by the features are merely exemplary. The present invention can be implemented by configurations other than the configurations disclosed in the following embodiments. The present invention can attain at least one of various effects (including derivative effects) attained by the configurations. In the present specification, ordinal numbers are assigned for the sake of convenience to discriminate members (components) and parts, and are not intended to indicate priority or order.

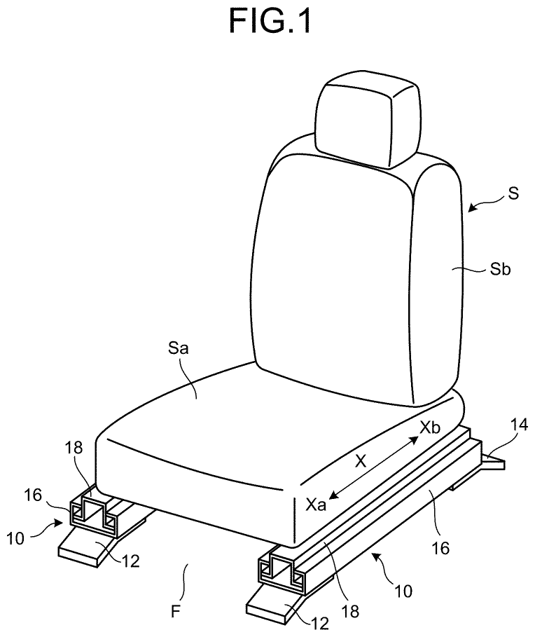

The following describes the overall structure of a vehicle seat on which a power seat slide device according to an embodiment is installed, with reference to FIG. 1. The power seat slide device is located between a seat S and a floor F in a vehicle interior. The power seat slide device includes a pair of right and left seat tracks 10 extending in a lengthwise direction X (frontward Xa, rearward Xb) of the vehicle. The right and left seat tracks 10 have the same (symmetrical) structure, and each include a lower rail 16 fixed to a front bracket 12 and a rear bracket 14 spaced apart from each other in the lengthwise direction X on the floor F, and an upper rail 18 secured on the back surface of a seat cushion Sa of the seat S. The upper rail 18 supports the seat S, and is fitted to the lower rail 16 secured on the floor F and is movable in the lengthwise direction X. The seat S may be also equipped with a reclining mechanism for reclining a backrest Sb with respect to the seat cushion Sa, a tilt mechanism for tilting the seat cushion Sa, and a lifting mechanism for elevating and lowering the seat cushion Sa. For example, the reclining mechanism may be disposed at a connecting part between the seat cushion Sa and the backrest Sb while the tilt mechanism and the lifting mechanism may be disposed between the power seat slide device and the seat cushion Sa.

### First Embodiment

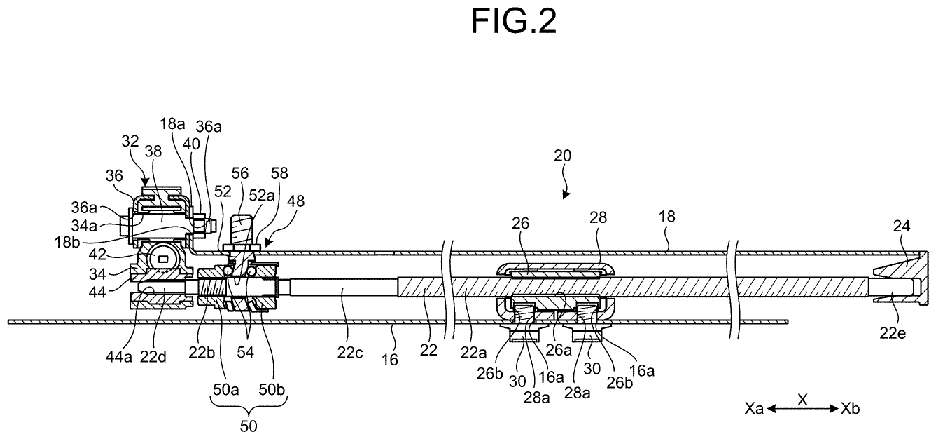

The following describes the overall structure of a power seat slide device 20 according to a first embodiment with reference to FIG. 2. In FIG. 2, the lower rail 16 and the upper rail 18 are placed in the lengthwise direction X of the vehicle. A rod screw member 22 is placed in the upper rail 18 in the longitudinal direction (lengthwise direction X). The rod screw member 22 includes a male screw 22a at a center on the periphery. The rod screw member 22A includes, at one end (front side, frontward Xa side), a small-diameter part 22c in continuous with the male screw 22a and partially including a male screw 22b. The small-diameter part 22c is smaller in outer diameter than the male screw 22a. The rod screw member 22 further includes, at a distal end, a serration 22d in continuous with the small-diameter part 22c and including serrations axially extending on the periphery. The serration 22d is smaller in outer diameter than the small-diameter part 22c. The rod screw member 22 includes, at the other end (rear side, rearward Xb side), a straight support 22e in continuous with the male screw 22a and including no screw. The upper rail 18 has a screw bracket 24 attached thereto into which the support 22e at the end of the rod screw member 22 is inserted. The screw bracket 24 is provided with a tapered support hole that is gradually decreased in diameter to the far side, to rotatably support the rod screw member 22.

A nut member 26 is housed in a nut housing 28 and fixed to the lower rail 16. The nut member 26 is provided with a through hole including a female screw 26a on the inner periphery in the inserting direction of the rod screw member 22. The female screw 26a of the nut member 26 is screwed with the male screw 22a of the rod screw member 22. The nut housing 28 is placed to cover the nut member 26. A vibration absorbing member such as a rubber sheet may be provided in the space between the inner surface of the nut housing 28 and the outer surface of the nut member 26. The nut housing 28 is provided with female fixation screws 28a at two locations on the bottom, for example. The nut member 26 is provided with an clearance hole 26b at a location corresponding to the female fixation screws 28a. The clearance hole 26b has a diameter larger than the female fixation screws 28a to avoid the distal end of a bolt 30 screwed into the female fixation screws 28a. The lower rail 16 is provided with a through hole 16a having a diameter larger than the female fixation screws 28a at a location corresponding to the female fixation screws 28a and the clearance hole 26b. Thus, the nut housing 28 is fixed to the lower rail 16 by inserting the bolt 30 into the through hole 16a and screwing it into the female fixation screws 28a.

The upper rail 18A includes, at one end (front part, frontward (Xa) end), a bend 18a that is bent upward. A gearbox 32 is fixed to the bend 18a.

The gearbox 32 includes a gear housing 34, and a cover 36 to which the gear housing 34 is attached, to cover the upper part of the gear housing 34. The gearbox 32 is attached to the bend 18a of the upper rail 18 by inserting a bolt 38 through a through hole 36a of the cover 36, a through hole 34a of the gear housing 34, and a through hole 18b of the bend 18a and screwing the bolt 38 into a nut 40.

The gear housing 34 accommodates a gear deceleration mechanism including a worm 42 driven by a motor (not illustrated) and a worm wheel 44 screwed with the worm 42. The worm wheel 44, being an output of the gear deceleration mechanism, is provided with a through hole including a serration 44a on the inner periphery along the rotation axis. The serration 22d of the rod screw member 22 is fitted with the serration 44a of the worm wheel 44. Due to the serration fitting, the worm wheel 44 and the rod screw member 22 rotate together while allowed to relatively move along the rotation axis (lengthwise direction X).

Rotated by the motor (not illustrated), the rod screw member 22 moves forward and rearward with respect to the nut member 26 fixed to the lower rail 16. That is, the upper rail 18 moves along the lower rail 16 in the lengthwise direction X. As described above, the seat S is secured on the upper rail 18, so that the seat S is movable with respect to the floor F in the lengthwise direction X.

In the first embodiment, the rod screw member 22 and the upper rail 18 are also connected through a load transmission mechanism 48. The load transmission mechanism 48 includes a screw fixing member 50 (a front screw fixing member 50a, a rear screw fixing member 50b) fixed to part of the rod screw member 22, a screw-through member 52 with a screw through hole 52a through which the rod screw member 22 rotatably passes, a plurality of roll members such as spheres 54 (metal balls, resin balls) located to slidably contact the screw fixing member 50 and the screw-through member 52. The screw-through member 52a integrally includes a male screw 56. The male screw 56 is inserted into a through hole of the upper rail 18 from the bottom, and screwed into a nut 58 on the top surface of the upper rail 18. Thus, the screw-through member 52, that is, the load transmission mechanism 48 is fixed to the upper rail 18 by fastening the male screw 56 and the nut 58.

That is, a load acting on the seat S is transmitted to the floor F via the upper rail 18, the load transmission mechanism 48, the rod screw member 22, the nut member 26, the nut housing 28, and the lower rail 16.

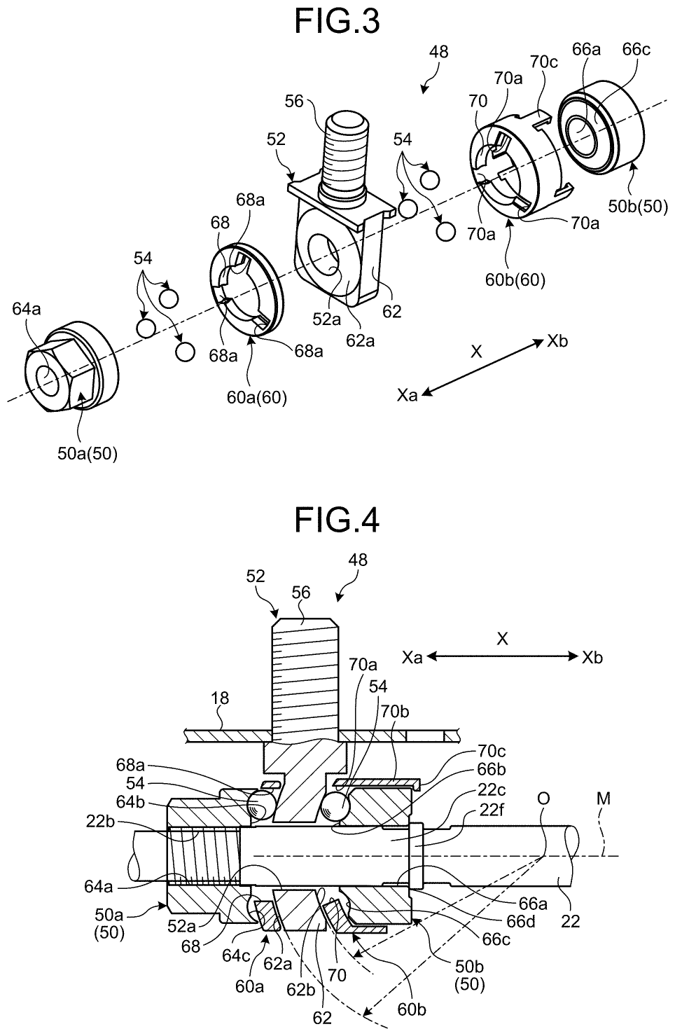

FIG. 3 illustrates an exploded perspective view of the load transmission mechanism 48, and FIG. 4 illustrates a cross-sectional view of the load transmission mechanism 48.

As illustrated in FIG. 3, the load transmission mechanism 48 includes the screw fixing member 50 (front screw fixing member 50a, rear screw fixing member 50b), the screw-through member 52, the spheres 54, and a guide member 60 (a front guide member 60a, and a rear guide member 60b). The load transmission mechanism 48 according to the first embodiment includes the front guide member 60a that supports a plurality of (three in FIG. 3) spheres 54, between a rear-side (rearward Xb) face of the front screw fixing member 50a fixed to the rod screw member 22 and a front-side (frontward Xa) face of the screw-through member 52 rotatable with respect to the rod screw member 22. Likewise, the load transmission mechanism 48 includes the rear guide member 60b that supports a plurality of (three in FIG. 3) spheres 54, between the front-side (frontward Xa) face of the rear screw fixing member 50b fixed to the rod screw member 22 and the rear-side (rearward Xb) face of the screw-through member 52. That is, due to the front screw fixing member 50a and the rear screw fixing member 50b fixed to the front and rear of the rod screw member 22 in the lengthwise direction X, the screw-through member 52 is supported by the rod screw member 22 while being rotatable with respect to the rod screw member 22 and substantially restricted from moving forward and rearward.

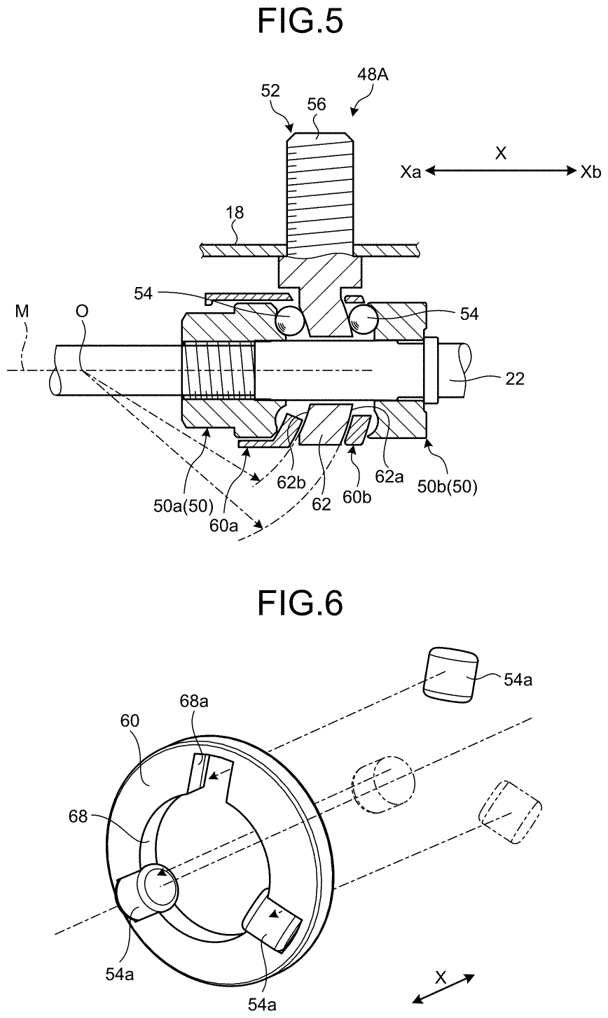

With reference to FIG. 4, first, the screw-through member 52 of the load transmission mechanism 48 is described in detail. By way of example, the screw-through member 52 includes a main body 62 of a substantially rectangular shape including a convex surface 62a on one side (frontward Xa) and a concave surface 62b on the other side (rearward Xb), and the male screw 56 integrated with the top surface of the main body 62. The main body 62 is provided with the screw through hole 52a through which the rod screw member 22 passes. The male screw 56 is positioned so that the center of the screw through hole 52a comes immediately below the rotation center of the male screw 56. The screw-through member 52 is made of, for example, metal such as iron. The convex surface 62a can be a curved surface projecting frontward Xa (axial direction) to a rotation center M of the rod screw member 22. The convex surface 62a is smoothly processed so as to be able to smoothly sliding contact with the spheres 54 (FIG. 4 shows only one sphere) supported by the front guide member 60a. Likewise, the concave surface 62b can be a curved surface that is recessed frontward Xa (axial direction) to the rotation center M of the rod screw member 22. The concave surface 62b is smoothly processed so as to be able to sliding contact with the spheres 54 (FIG. 4 shows only one sphere) supported by the rear guide member 60b. In FIG. 4, the frontward Xa side of the screw-through member 52 is the convex surface 62a, and the rearward Xb side is the concave surface 62b. However, the embodiment is not limited thereto. As illustrated in FIG. 5, the positions of the convex surface 62a and the concave surface 62b may be reversed. Alternatively, both of the surfaces of the screw-through member 52 may be recessed or protruded.

The front screw fixing member 50a (screw fixing member 50) is a cylindrical member with a through hole through which the rod screw member 22 passes and including a female screw 64a to be screwed with the male screw 22b of the rod screw member 22. The front screw fixing member 50a is made of metal such as iron, for example, and is fixed to part of the rod screw member 22 to rotate together. The front screw fixing member 50a may be a nut. For example, the female screw 64a has a diameter slightly smaller than the diameter of the male screw 22b of the rod screw member 22, so that the front screw fixing member 50a can be press-fitted into the male screw 22b and secured on the rod screw member 22. The fixing position of the front screw fixing member 50a can be set depending on the position of the male screw 22b. The front screw fixing member 50a may be fixed to the rod screw member 22 in a different manner. For example, the female screw 64a of the front screw fixing member 50a may have a diameter corresponding to the diameter of the male screw 22b, and they may be fixed by swaging or welding after being screwed together and positioned.

The front screw fixing member 50a is provided with a slide groove 64c in an end face 64b on the screw-through member 52 side. The slide groove 64c circumferentially extends to receive part of the surfaces of the spheres 54 and support the spheres 54 in a rollable manner. The slide groove 64c has a depth sufficient to receive, for example, ¼ of the diameter of the spheres 54, and a curvature equivalent to or slightly smaller than the curvature of the spheres 54. Thus, the spheres 54 can smoothly roll in the slide groove 64c.

The rear screw fixing member 50b (screw fixing member 50) is a cylindrical member with a through hole 66a through which the rod screw member 22 passes. The rear screw fixing member 50b is fixed to part of the rod screw member 22 to rotate together, and is made of metal, for example. The through hole 66a of the rear screw fixing member 50b may be slightly smaller in diameter than the small-diameter part 22c of the rod screw member 22, for example, and can be fixed to the small-diameter part 22c by press fitting. A method of fixing the rear screw fixing member 50b to the rod screw member 22 is not limited thereto. The rear screw fixing member 50b may be fixed to the rod screw member 22 by swaging or welding, for example. For positioning the rear screw fixing member 50b in the small-diameter part 22c, for example, an end face 66d of the rear screw fixing member 50b on the rearward Xb side may abut on a large-diameter part 22f located in the small-diameter part 22c.

The rear screw fixing member 50b is provided with a slide groove 66c at an end face 66b on the screw-through member 52 side. The slide groove 66c circumferentially extends to receive part of the surfaces of the spheres 54 and support the spheres 54 in a rollable manner. The slide groove 66c has a depth sufficient to receive, for example, ¼ of the diameter of the spheres 54, and has a curvature equivalent to or slightly smaller than the curvature of the spheres 54. Thus, the spheres 54 can smoothly roll inside the slide groove 66c.

The spheres 54, which slide between the screw-through member 52 and the front screw fixing member 50a, are supported by the front guide member 60a (guide member 60) located between the screw-through member 52 and the front screw fixing member 50a in the lengthwise direction X. The front guide member 60a is placed to maintain the intervals among the spheres 54 in the circumferential direction of the rod screw member 22, and to be rotatable relative to at least one of the screw-through member 52 and the front screw fixing member 50a. The front guide member 60a according to the first embodiment is situated rotatably relative to both of the screw-through member 52 and the front screw fixing member 50a. The front guide member 60a is an annular member made of resin, for example, and provided with a guide through hole 68 through which the rod screw member 22 passes, as illustrated in FIG. 3. The guide through hole 68 has guide grooves 68a functioning as holders that hold (guide) the spheres 54 at regular intervals, for example. The guide grooves 68a radially extend from the periphery of the guide through hole 68 toward radially outside the front guide member 60a. In FIG. 3, three guide grooves 68a are formed at 120-degree intervals corresponding to the number of the spheres 54 to guide.

Thus, along with the rotation of the front screw fixing member 50a and the rod screw member 22, the spheres 54 and the front guide member 60a freely rotate in the circumferential direction of the rod screw member 22 while the spheres 54 maintain the circumferential intervals without being affected by the rotation of the front screw fixing member 50a. As a result, the spheres 54 roll on the convex surface 62a of the screw-through member 52 at a low resistance. That is, during undulatory rotation of the rod screw member 22, the relative position of the front screw fixing member 50a and the screw-through member 52 is smoothly changed, thereby abating variation in rotational resistance of the rod screw member 22 due to the undulation. In other words, variation in the rotational speed of the rod screw member 22 can be reduced.

The spheres 54, which slide between the screw-through member 52 and the rear screw fixing member 50b, are supported by the rear guide member 60b (guide member 60) located between the screw-through member 52 and the rear screw fixing member 50b in the lengthwise direction X. As with the front guide member 60a, the rear guide member 60b is placed to maintain the intervals among the spheres 54 in the circumferential direction of the rod screw member 22, and to be rotatable relative to at least one of the screw-through member 52 and the rear screw fixing member 50b. The rear guide member 60b according to the first embodiment is placed to be rotatable relative to both of the screw-through member 52 and the rear screw fixing member 50b. The rear guide member 60b is made of, for example, resin. As illustrated in FIG. 3, the rear guide member 60b is a cylindrical member with a bottom and is provided at one side with a guide through hole 70 through which the rod screw member 22 passes, and can house part of the rear screw fixing member 50b inside. The guide through hole 70 has a plurality of guide grooves 70a functioning as holders that hold (guide) the spheres 54 at regular intervals, for example. The guide grooves 70a radially extend from the periphery of the guide through hole 70 toward radially outside the rear guide member 60b. In FIG. 3, three guide grooves 70a are formed at 120-degree intervals corresponding to the number of the spheres 54 to guide. A cylindrical part 70b of the rear guide member 60b includes a temporary joint 70c extending rearward Xb. During assembly of the load transmission mechanism 48, the temporary joint 70c becomes engaged with the end face of the rear screw fixing member 50b on the rearward Xb side to temporarily joint with the rear guide member 60b, improving assembling performance. The temporary joint 70c is loosely fitted to the rear screw fixing member 50b not to hinder relative rotation of the rear guide member 60b and the rear screw fixing member 50b after assembly.

Thus, along with the rotation of the rear screw fixing member 50b and the rod screw member 22, the spheres 54 and the rear guide member 60b freely rotate in the circumferential direction of the rod screw member 22 while the spheres 54 maintain the circumferential intervals without being affected by the rotation of the rear screw fixing member 50b. As a result, the spheres 54 roll on the concave surface 62b of the screw-through member 52 at a low resistance. That is, during undulatory rotation of the rod screw member 22, the relative position of the rear screw fixing member 50b and the screw-through member 52 is smoothly changed, thereby abating variation in rotational resistance of the rod screw member 22 due to the undulation. In other words, variation in the rotational speed of the rod screw member 22 can be reduced.

In the load transmission mechanism 48, the guide member 60 works to maintain the intervals among the spheres 54 in the circumferential direction of the rod screw member 22. Thus, even with a less number of spheres 54 placed, the screw-through member 52 and the screw fixing member 50 can be maintained in parallel in a contact state in the lengthwise direction X. With three or more spheres 54 provided, for example, the screw-through member 52 and the screw fixing member 50 are supported at at least three points, and can be therefore prevented from tilting at the time of sliding contact with each other. As a result, the screw-through member 52 and the screw fixing member 50 can be smoothly moved relative to each other. In FIG. 4, the front guide member 60a is placed to be rotatable relative to (not fixed to) both of the screw-through member 52 and the front screw fixing member 50a. However, in another embodiment, the front guide member 60a may be fixed to (integrated with) either of the screw-through member 52 and the front screw fixing member 50a. In this case, the spheres 54 roll inside the guide groove 68a without moving in the circumferential direction. Likewise, the rear guide member 60b is placed to be rotatable relative to (not fixed to) both of the screw-through member 52 and the rear screw fixing member 50b. In another embodiment, however, the rear guide member 60b may be fixed to (integrated with) either of the screw-through member 52 and the rear screw fixing member 50b. In this case, the spheres 54 roll inside the guide groove 70a without moving in the circumferential direction. Thus, integrating the front guide member 60a or the rear guide member 60b with a component ahead or behind can contribute to reducing the number of components and man-hours for assembly.

The following describes an operation of the load transmission mechanism 48 configured as above. As described above, to slide the seat S supported by the upper rail 18 in the lengthwise direction X, the rod screw member 22 is rotated by the motor. As illustrated in FIG. 2, the rod screw member 22 is rotatably supported by the upper rail 18, and screwed into the nut member 26 fixed to the lower rail 16 on the floor F. As a result, the rod screw member 22, while rotating, moves forward and rearward with reference to the nut member 26 in the lengthwise direction X. The position of the screw-through member 52 fixed to the upper rail 18 is set on the rotating rod screw member 22 by the front screw fixing member 50a and the rear screw fixing member 50b fixed to the rod screw member 22 via the spheres 54. Thus, the screw fixing member 50 fixed to the rod screw member 22 pushes the screw-through member 52, causing the upper rail 18 fixed to the screw-through member 52, that is, the seat S, to slide in the lengthwise direction X.

As described above, the screw-through member 52 is fixed to the upper rail 18 with the male screw 56 and the nut 58. In fixing the male screw 56 to the upper rail 18, the angle of the fixed screw-through member 52 may vary in the rotation direction of the male screw 56. That is, the positional relationship among the screw-through member 52, the rod screw member 22, and the front screw fixing member 50a and the rear screw fixing member 50b fixed to the rod screw member 22 may vary. As a result, the rod screw member 22, to which the front screw fixing member 50a and the rear screw fixing member 50b are fixed, may undulate in rotation. If, without the spheres 54 in-between, the screw-through member 52, the front screw fixing member 50a, and the rear screw fixing member 50b are in surface contact with one another, it is difficult for the rod screw member 22 to rotate with respect to the screw-through member 52 due to the undulation. That is, the rotational speed of the rod screw member 22 may be increased or decreased, thereby causing vibration or unusual noise at the time when the seat S is slid.

Meanwhile, in the first embodiment the spheres 54 are interposed between the screw-through member 52, and the front screw fixing member 50a and the rear screw fixing member 50b, therefore, the front screw fixing member 50a and the rear screw fixing member 50b are in point contact with the screw-through member 52. As a result, in undulatory rotation of the rod screw member 22, the relative position between the screw-through member 52, and the front screw fixing member 50a and the rear screw fixing member 50b is easily changeable at low resistance. That is, the rod screw member 22 in undulatory rotation is unlikely to receive resistance. As a result, the rod screw member 22 smoothly rotates while undulating. This can abate increase or decrease in the rotational speed of the rod screw member 22 due to the undulation and reduce occurrence of vibration or unusual noise at the time when the seat S is slid.

The circular arc of the convex surface 62a and the circular arc of the concave surface 62b can be part of circular arcs of different radii centered on the same point O on the rotation center M of the rod screw member 22. Owing to the convex surface 62a and the concave surface 62b being part of the circular arcs about the same point O, when the rod screw member 22 undulates around the point O, the relative position between the screw-through member 52 and the guide member 60 is changed more smoothly. This can reduce influence of the undulation, that is, efficiently reduce variation in the rotation of the rod screw member 22, enabling the rod screw member 22 to smoothly rotate.

In the load transmission mechanism 48 illustrated in FIG. 4, as described above, one side (for example, rearward Xb side) of the screw-through member 52 is formed as the concave surface 62b that is recessed in the axial direction (frontward Xa) toward the rotation center M of the rod screw member 22 and that serves as a sliding contact surface with which the spheres 54 are in sliding contact, by way of example. In this case, for example, when the load transmission mechanism 48 receives rearward (Xb) external force (for example, a load from sudden acceleration), the concave surface 62b of the screw-through member 52 works to press down the spheres 54 toward the rotation center M (axis) of the rod screw member 22. That is, the spheres 54 are prevented from protruding toward the outer circumference of the rear guide member 60b. This can avoid the spheres 54 from deforming or damaging the rear guide member 60b and falling off therefrom, when an excessively large rearward (Xb) load is applied to the screw-through member 52. That is, the load transmission mechanism 48 can have an advantageous structure in terms of strength against a rearward load.

In the load transmission mechanism 48 illustrated in FIG. 4, as described above, the other side (for example, frontward Xa side) of the screw-through member 52 is formed as the convex surface 62a protruding in the axial direction (frontward Xa) toward the rotation center M of the rod screw member 22 and serves as a sliding contact face with which the spheres 54 are in sliding contact, by way of example. In this case, for example, in fixing the load transmission mechanism 48 to the upper rail 18 as described above, assembly error (rotation) in the rotation direction of the male screw 56 may occur or the rod screw member 22 may undulate while rotating, causing the contact position between the spheres 54 and the convex surface 62a of the screw-through member 52 to be changed, however, they can be maintained in a point contact state. Thus, the front screw fixing member 50a and the screw-through member 52 are stably changeable in position relative to each other. This makes it possible to prevent variation in the rotation speed of the undulating rod screw member 22, allowing the upper rail 18 (seat S) to smoothly slide with reduced vibration or unusual noise.

To form the sliding contact surface (concave surface 62b) with the spheres 54 as a concave surface recessed in the axial direction toward the rotation center M of the rod screw member 22, as illustrated in FIG. 4, the concave surface needs to have a curvature smaller than the curvature of the spheres 54. In this case, the spheres 54 can be not in multipoint contact or surface contact but in point contact with the concave surface 62b. As a result, upon receiving an excessively large load, the concave surface 62b effectively presses the spheres 54 toward the rotation center M of the rod screw member 22, in addition to the effect of the convex surface 62a in point contact, i.e., smoothly and stably changing the relative position of the rear screw fixing member 50b and the screw-through member 52, as described above.

In the load transmission mechanism 48 illustrated in FIG. 4, the frontward Xa side of the screw-through member 52 is the convex surface 62a, and the rearward Xb side thereof is the concave surface 62b by way of example. However, the relation between the convex surface 62a and the concave surface 62b is not limited thereto. For example, as illustrated in FIG. 5, the frontward Xa side of the screw-through member 52 may be the concave surface 62b, and the rearward Xb side thereof may be the convex surface 62a. A load transmission mechanism 48A illustrated in FIG. 5 and the load transmission mechanism 48 illustrated in FIG. 4 have the same basic structure except for the reverse relation between the convex surface 62a and the concave surface 62b of the screw-through member 52. Thus, the same elements are denoted by the same reference numerals, and redundant descriptions will not be repeated.

In the load transmission mechanism 48A as configured in FIG. 5, while the rod screw member 22 rotates and undulates, the spheres 54 roll, thereby smoothly changing the positional relationship between the screw-through member 52, and the front screw fixing member 50a and the rear screw fixing member 50b. Consequently, the load transmission mechanism 48A can attain the same or like effects as the load transmission mechanism 48. That is, the rod screw member 22 can be prevented from varying in the rotational speed during undulatory rotation, enabling the upper rail 18 (seat S) to smoothly slide with reduced vibration or unusual noise.

In the load transmission mechanism 48A illustrated in FIG. 5, the screw-through member 52 has the concave surface 62b on the frontward Xa side, so that, when the load transmission mechanism 48A receives frontward (Xa) external force (such as a load from sudden deceleration), for example, the concave surface 62b of the screw-through member 52 presses down the spheres 54 toward the rotation center M (axis) of the rod screw member 22. That is, the spheres 54 are prevented from protruding toward the outer circumference of the front guide member 60a. Thus, even with an excessively large frontward (Xa) load applied to the screw-through member 52, it is possible to avoid the spheres 54 from deforming or damaging the front guide member 60a and falling off from the front guide member 60a. In other words, the load transmission mechanism 48A can have an advantageous structure in terms of strength against a forward load.

In the load transmission mechanism 48A, the screw-through member 52 has the convex surface 62a on the rearward Xb side. As with the load transmission mechanism 48, thus, if, in fixing the load transmission mechanism 48A to the upper rail 18, assembly error (rotation) occurs in the rotation direction of the male screw 56 or the rod screw member 22 is undulated during rotation, the contact position between the spheres 54 and the convex surface 62a on the rearward Xb side of the screw-through member 52 may be changed, however, they can be maintained in the point contact state. As a result, the rear screw fixing member 50b and the screw-through member 52 are stably changed in position relative to each other. This prevents variation in the rotation speed of the undulating rod screw member 22, enabling the upper rail 18 (seat S) to smoothly slide with reduced vibration or unusual noise.

In the load transmission mechanism 48A, the circular arc of the convex surface 62a and the circular arc of the concave surface 62b may be part of circular arcs of have different radii centered on the same point O on the rotation center M of the rod screw member 22. By setting the convex surface 62a and the concave surface 62b to part of the circular arcs about the same point O, undulation of the rod screw member 22 around the point O causes the screw-through member 52 and the guide member 60 to be smoothly changed in position relative to each other. This makes it possible to smoothly rotate the rod screw member 22 with reduced influence of the undulation, that is, efficiently reduced variation in rotation of the rod screw member 22.

In the load transmission mechanism 48 illustrated in FIG. 4, the center of undulation (point O) is located on the rearward Xb side of the screw-through member 52, that is, closer to the nut member 26 screwed with the rod screw member 22. Meanwhile, in the load transmission mechanism 48A illustrated in FIG. 5, the center of undulation (point O) is located on the frontward Xa side of the screw-through member 52, that is, more distant from the nut member 26 than in FIG. 4. That is, in the load transmission mechanism 48 illustrated in FIG. 4 the rod screw member 22 exerts a less amount of undulation (range of shaking) than in the load transmission mechanism 48A illustrated in FIG. 5. Thus, by appropriate selection of a curved shape of the screw-through member 52, the amount of undulation of the rod screw member 22 can be managed.

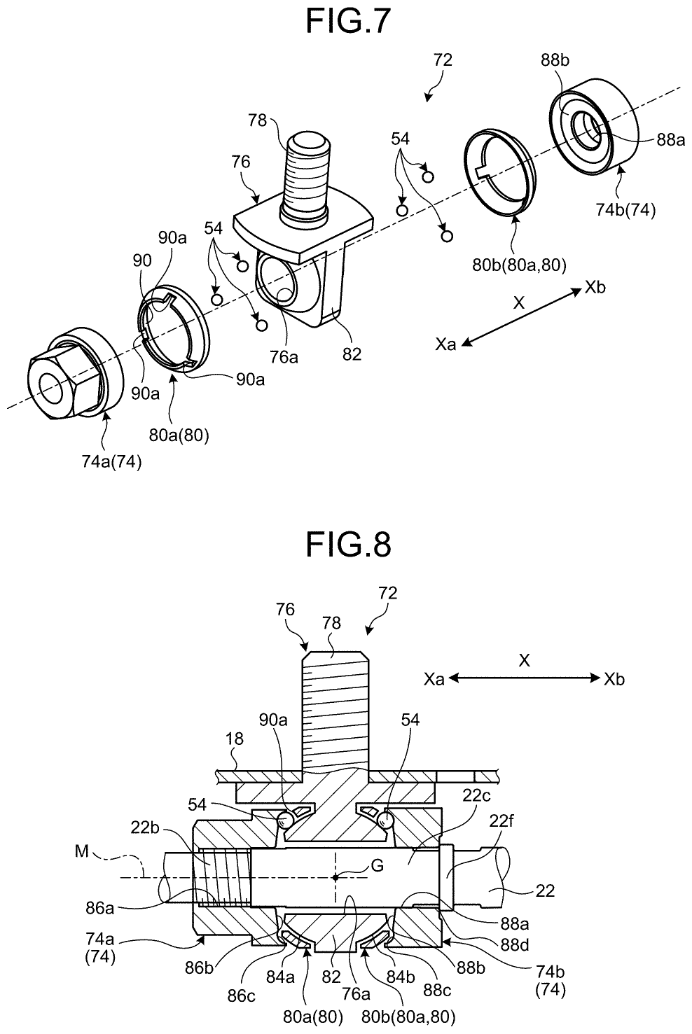

In the examples of the load transmission mechanism 48 illustrated in FIG. 4 and the load transmission mechanism 48A illustrated in FIG. 5, the main body 62 of the screw-through member 52 has the convex surface 62a on one side and the concave surface 62b on the other side. However, the embodiment is not limited thereto. For example, as described later in detail with reference to FIG. 7 and FIG. 8, the main body 62 may have convex surfaces 62a or concave surfaces 62b on both sides. Because of the concave surfaces 62b on both sides of the main body 62, the screw-through member 52 can press down the spheres 54 toward the rotation center M (axis) of the rod screw member 22 irrespective of receiving an excessively large rearward or forward load. Thus, with an excessively large load acting on the screw-through member 52, it is possible to avoid the spheres 54 from deforming or damaging the front guide member 60a or the rear guide member 60b and the spheres 54 from flouncing off (falling off) from the front guide member 60a or the rear guide member 60b. That is, the screw-through member 52a can have an advantageous structure in terms of strength against forward and rearward loads.

As a modification, in the case of less undulation of the rod screw member 22 during rotation or forming another structure to deal with the undulation, for example, the main body 62 of the screw-through member 52 may have flat surfaces on both sides in the lengthwise direction X. In this case, the end face 64b of the front screw fixing member 50a and the end face 66b of the rear screw fixing member 50b, which oppose the screw-through member 52 via the spheres 54, may also be flat faces. As with the above embodiment, the end face 64b may be provided with the slide groove 64c, or the end face 66b may be provided with the slide groove 66c. Also in this structure, the interposed spheres 54 improve a sliding performance between the screw-through member 52, and the front screw fixing member 50a and the rear screw fixing member 50b in comparison with no spheres 54 interposed. This results in simplifying the structure of the screw-through member 52, reducing component cost and implementing smooth sliding of the seat S.

As described above, when the contact surfaces between the screw-through member 52 and the spheres 54 are flat, cylindrical rollers 54a may be, for example, used as roll members between the screw-through member 52 and the front screw fixing member 50a, and between the screw-through member 52 and the rear screw fixing member 50b as illustrated in FIG. 6. In this case, the guide member 60 functioning as a holder that holds (guides) the rollers 54a may be, for example, an annular plate member made of resin. The guide member 60 is provided with the guide through hole 68 through which the rod screw member 22 passes, and a plurality of guide grooves 68a radially extending to direct the rotation axes of the rollers 54a to the center of the guide member 60. FIG. 6 shows three guide grooves 68a formed at regular intervals (120° intervals), by way of example. The number of rollers 54a may be appropriately changed so long as the number is equal to or larger than three. The rollers 54a can attain effects similar to the spheres 54.

### Second Embodiment

FIG. 7 illustrates an exploded perspective view of a load transmission mechanism 72 according to a second embodiment, and FIG. 8 illustrates a cross-sectional view of the load transmission mechanism 72. The load transmission mechanism 72 according to the second embodiment includes, as an example, a screw-through member 52 with a main body 62 having convex surfaces 62a on both sides, as described in the load transmission mechanism 48 of the first embodiment. Thus, by using the load transmission mechanism 72 in place of the load transmission mechanism 48 in FIG. 2, it is possible to attain a power seat slide device 20 that can reduce variation in the rotational speed of the rod screw member 22 in undulatory rotation. The following describes the structure of the load transmission mechanism 72. The same or like elements as those of the transmission mechanism 48 are denoted by the same reference numerals, and redundant descriptions will not be repeated.

As illustrated in FIG. 7, the load transmission mechanism 72 includes a screw fixing member 74 (a front screw fixing member 74a, a rear screw fixing member 74b), a screw-through member 76, spheres 54, and a guide member 80 (a front guide member 80a, a rear guide member 80b). As with the load transmission mechanism 48, the load transmission mechanism 72 according to the second embodiment includes the front guide member 80a that supports a plurality of (three in FIG. 7) spheres 54 serving as roll members. The front guide member 80a is placed between the rear side (rearward Xb) of the front screw fixing member 74a fixed to the rod screw member 22 and the front side (frontward Xa) of the screw-through member 76 rotatable with respect to the rod screw member 22. Likewise, the rear guide member 80b is placed between the front side (frontward Xa) of the rear screw fixing member 74b fixed to the rod screw member 22 and the rear side (rearward Xb) of the screw-through member 76, for supporting a plurality of (three in FIG. 7) spheres 54. That is, the screw-through member 76 is rotatably supported by the rod screw member 22 through the front screw fixing member 74a and the rear screw fixing member 74b fixed at the front and rear of the rod screw member 22 in the lengthwise direction X, while substantially restricted from moving forward and rearward.

The screw-through member 76 is now described in detail with reference to FIG. 8. The screw-through member 76 includes a main body 82 of a substantially rectangular shape having convex surfaces on both the frontward Xa and rearward Xb sides, and a male screw 78 integrated with the top face of the main body 82. The main body 82 is provided with a screw through hole 76a through which the rod screw member 22 can pass. The male screw 78 is positioned so that the center of the screw through hole 76a comes immediately below the rotation center of the male screw 78. The screw-through member 76 is made of, for example, metal such as iron. A convex surface 84a and a convex surface 84b can be both curved surfaces protruding toward the rotation center M of the rod screw member 22. The convex surface 84a is smoothly processed so as to be able to smoothly come into sliding contact with the spheres 54 (FIG. 8 shows only one sphere) supported by the front guide member 80a. Likewise, the convex surface 84b is smoothly processed to be able to smoothly come into sliding contact with the spheres 54 (FIG. 8 shows only one sphere) supported by the rear guide member 80b.

The front screw fixing member 74a (screw fixing member 74) is a cylindrical member with a through hole, through which the rod screw member 22 passes, having formed inside a female screw 86a to be screwed with the male screw 22b of the rod screw member 22. The front screw fixing member 74a is fixed to part of the rod screw member 22 to rotate together, and is made of metal such as iron, for example. The front screw fixing member 74a may be a nut. For example, the female screw 86a is slightly smaller in diameter than the male screw 22b of the rod screw member 22, so that the front screw fixing member 74a can be screwed into the male screw 22b by press-fitting for fixation. The fixing position of the front screw fixing member 74a can be set depending on the position of the male screw 22b. The front screw fixing member 74a may be fixed to the rod screw member 22 in a different manner. For example, the female screw 86a of the front screw fixing member 74a may have a diameter corresponding to the diameter of the male screw 22b, to be fixed by swaging or welding after being screwed together and positioned.

An end face 86b of the front screw fixing member 74a closer to the screw-through member 76 is provided with a slide groove 86c circumferentially extending to receive part of the surfaces of the spheres 54 and support the spheres 54 in a rollable manner. The slide groove 86c has a depth sufficient to receive, for example, ¼ of the diameter of the spheres 54, and a curvature set equivalent to or slightly smaller than the curvature of the spheres 54. Thus, the spheres 54 are smoothly rollable in the slide groove 86c.

The rear screw fixing member 74b (screw fixing member 74) is a cylindrical member with a through hole 88a through which the rod screw member 22 passes. The rear screw fixing member 74b is fixed to part of the rod screw member 22 to rotate together, and is made of metal, for example. For example, the through hole 88a of the rear screw fixing member 74b can be slightly smaller in diameter than the small-diameter part 22c of the rod screw member 22, to be fixed to the small-diameter part 22c by press-fitting. The rear screw fixing member 74b may be fixed to the rod screw member 22 in a different manner such as swaging, welding, or screw fastening, for example. The rear screw fixing member 74b may be positioned in the small-diameter part 22c by, for example, allowing an end face 88d of the rearward Xb side of the rear screw fixing member 74b to abut on the large-diameter part 22f in the small-diameter part 22c.

An end face 88b of the rear screw fixing member 74b closer to the screw-through member 76 is provided with a slide groove 88c that circumferentially extends to receive part of the surfaces of the spheres 54 and support the spheres 54 in a rollable manner. The slide groove 88c has a depth sufficient to receive, for example, ¼ of the diameter of the spheres 54, and a curvature set equivalent to or slightly smaller than the curvature of the spheres 54. Thus, the spheres 54 can smoothly roll in the slide groove 88c.

The spheres 54, which slide between the screw-through member 76 and the front screw fixing member 74a, are supported by the front guide member 80a (guide member 80) located between the screw-through member 76 and the front screw fixing member 74a in the lengthwise direction X. The front guide member 80a is placed to maintain the intervals among the spheres 54 in the circumferential direction of the rod screw member 22, and to be rotatable relative to at least one of the screw-through member 76 and the front screw fixing member 74a. The front guide member 80a according to the second embodiment is placed in a rotatable state relative to both of the screw-through member 76 and the front screw fixing member 74a. The front guide member 80a is an annular member made of resin, for example, and provided with a guide through hole 90 through which the rod screw member 22 passes, as illustrated in FIG. 7. The guide through hole 90a has formed therein a plurality of guide grooves 90a functioning as holders that hold (guide) the spheres 54 at regular intervals, for example. The guide grooves 90a radially extend from the periphery of the guide through hole 90 toward radially outside the front guide member 80a. In FIG. 7, three guide grooves 90a are formed at 120-degree intervals corresponding to the number of the spheres 54 to guide.

Thus, along with the rotation of the front screw fixing member 74a and the rod screw member 22, the spheres 54 and the front guide member 80a freely rotate in the circumferential direction of the rod screw member 22 while the spheres 54 maintain the circumferential intervals without being affected by the rotation of the front screw fixing member 74a. As a result, the spheres 54 roll on the convex surface 84a of the screw-through member 76 at a low resistance. That is, when the rod screw member 22 undulates while rotating, the front screw fixing member 74a and the screw-through member 76 are smoothly changed in position relative to each other. This can abate variation in rotational resistance of the rod screw member 22 due to the undulation. That is, variation in the rotational speed of the rod screw member 22 can be reduced.

The spheres 54, which slide between the screw-through member 76 and the rear screw fixing member 74b, is supported by the rear guide member 80b (guide member 80) located between the screw-through member 76 and the rear screw fixing member 74b in the lengthwise direction X. In the case of the screw-through member 76 having the convex surface 84a and the convex surface 84b of the same shape, the rear guide member 80b can double as the front guide member 80a, or vice versa. The front and back sides of the front guide member 80a doubling as the rear guide member 80b can be simply reversed to support the spheres 54 between the screw-through member 76 and the rear screw fixing member 74b in a rollable manner. In this case, the number of types of components can be reduced, which can contribute to reducing design cost, component cost, and component management cost, for example.

The convex surface 84a and the convex surface 84b of the main body 82 of the screw-through member 76 may be, for example, part of a spherical surface centered on a point G being an intersection point between the rotation axis of the rod screw member 22 and the rotation axis of the male screw 78 of the screw-through member 76. In this case, if, in securing the load transmission mechanism 72 in the upper rail 18, assembly error (rotation) occurs in the rotation direction of the male screw 78 or the rod screw member 22 undulates while rotating, for example, the rod screw member 22 undulates around the point G. That is, the front screw fixing member 74a and the rear screw fixing member 74b smoothly roll on the convex surface 84a and the convex surface 84b of the screw-through member 76 via the spheres 54. This results in abating resistance to the rotation of the rod screw member 22 arising from the undulation, which is caused by the assembly error or error in dimensional accuracy of each member. That is, it is possible to abate variation in the rotational speed of the rod screw member 22, and reduce occurrence of vibration or unusual noise at the time when the upper rail 18 (seat S) is slid.

As for the screw-through member 76, the front guide member 80a is also placed to be rotatable to relative to the screw-through member 76 and the front screw fixing member 74a. Likewise, the rear guide member 80b is placed to be rotatable relative to the screw-through member 76 and the rear screw fixing member 74b. Thus, along with the rotation of the front screw fixing member 74a and the rear screw fixing member 74b with the rod screw member 22, the spheres 54, the front guide member 80a, and the rear guide member 80b freely rotate in the circumferential direction of the rod screw member 22 while the spheres 54 maintain their circumferential intervals without being affected by the rotation of the front screw fixing member 74a and the rear screw fixing member 74b. As a result, the spheres 54 roll on the convex surface 84a and the convex surface 84b of the screw-through member 76 at a low resistance. That is, irrespective of the undulatory rotation of the rod screw member 22, the screw-through member 76 and the front screw fixing member 74a, and the screw-through member 76 and the rear screw fixing member 74b are more smoothly moved in position relative to each other, which leads to making the rotational speed of the rod screw member 22 more constant.

In the load transmission mechanism 72, the intervals among the spheres 54 in the circumferential direction of the rod screw member 22 are maintained by the guide member 80. Thus, with a less number of spheres 54 disposed, the screw-through member 76 and the screw fixing member 74 can be maintained in parallel in a contact state in the lengthwise direction X. For example, with three or more spheres 54, the screw-through member 76 and the screw fixing member 74 can be supported at least three points and prevented from tilting when slide-contacting with each other. As a result, the screw-through member 76 and the screw fixing member 74 can smoothly move relative to each other. In another embodiment, the front guide member 80a may be fixed to or be integrated with either of the screw-through member 76 and the front screw fixing member 74a. Similarly, the rear guide member 80b may be fixed to or integrated with either of the screw-through member 76 and the rear screw fixing member 74b. In this case, the number of types of components can be reduced, which can contribute to reducing design cost, component cost, component management cost, and man-hours for assembly.

In the load transmission mechanism 72, as described above, the screw-through member 76 includes, on both sides in the lengthwise direction X, the convex surface 84a and the convex surface 84b protruding toward the rotation center M of the rod screw member 22 and serving as sliding contact surfaces to come into sliding contact with the spheres 54. In this case, for example, if, in fixing the load transmission mechanism 72 to the upper rail 18 as described above, assembly error (rotation) occurs in the rotation direction of the male screw 78 or the rod screw member 22 undulates while rotating, the contact position between the convex surface 84a (84b) of the screw-through member 76 and the spheres 54 may be changed, however, they are maintained in a point contact state. Consequently, the relative position of the front screw fixing member 74a (rear screw fixing member 74b) and the screw-through member 52 can be stably changed. This makes it possible to prevent variation in the rotational speed of the undulating rod screw member 22, enabling the upper rail 18 (seat S) to smoothly slide with reduced vibration or unusual noise.

In the above example, the main body 82 of the screw-through member 76 includes the convex surfaces 84a and 84b on both sides. Alternatively, they may be flat surfaces. The end face 86b of the front screw fixing member 74a is provided with the slide groove 86c, and the end face 88b of the rear screw fixing member 74 is provided with the slide groove 88c by way of example. However, the end face 86b and the end face 88b may be flat faces. With such flat end faces, the spheres 54 as a roll member may be used, or in place of the spheres 54, the cylindrical rollers 54a described with reference to FIG. 6 may be used, for example. In this case, as with the first embodiment using the rollers 54a, the second embodiment can attain effects similar to those by using the spheres 54.

### Third Embodiment

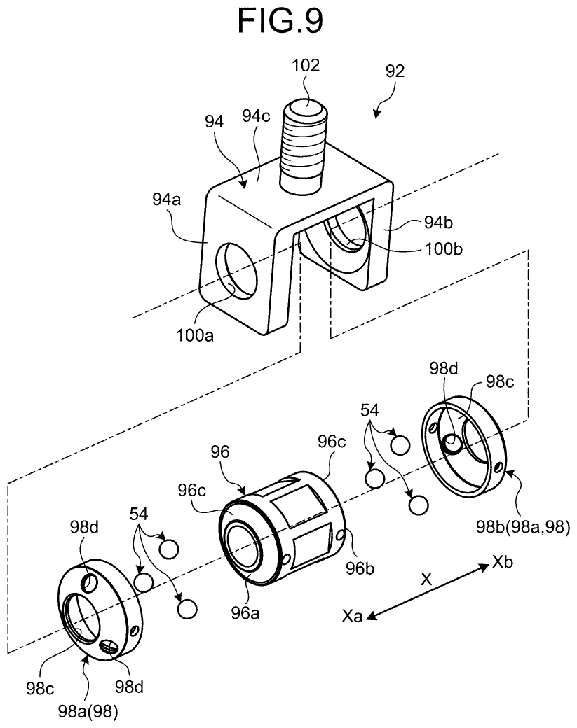

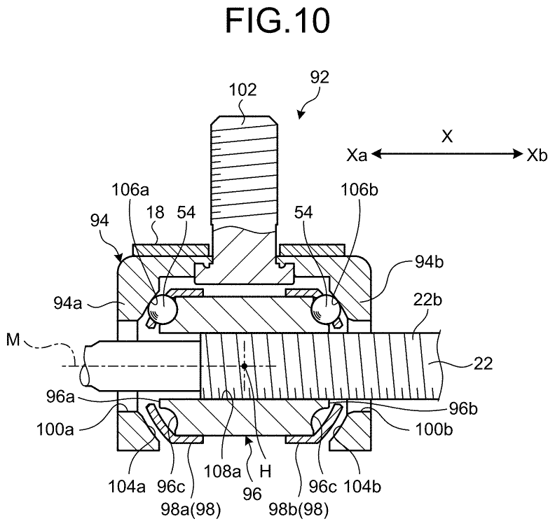

FIG. 9 illustrates an exploded perspective view of a load transmission mechanism 92 according to a third embodiment, and FIG. 10 illustrates a cross-sectional view of the load transmission mechanism 92. As illustrated in FIG. 9, the load transmission mechanism 92 according to the third embodiment includes a screw-through member 94 (bracket) fixed to the upper rail 18, a screw fixing member 96, spheres 54, and a guide member 98 (a front guide member 98a, a rear guide member 98b) that guides the spheres 54.

As illustrated in FIG. 9 and FIG. 10, the screw-through member 94 of the load transmission mechanism 92 has a substantially C-shaped cross section in the lengthwise direction X, including a front wall 94a and a rear wall 94b to hold a pair of end faces of the screw fixing member 96 in-between, and a connection 94c extending across the screw fixing member 96 in the lengthwise direction X to connect the front wall 94a and the rear wall 94b. The screw-through member 94 is made of metal (for example, iron), and the front wall 94a and the rear wall 94b are provided at about the center in the lengthwise direction X with a front through hole 100a and a rear through hole 100b through which the rod screw member 22 rotatably passes, respectively. The connection 94c is provided at about the center in the lengthwise direction X with a through hole penetrating in the vertical direction of the vehicle, and to which a bolt 102 is inserted and fixed. As with the other embodiments, the load transmission mechanism 92 (screw-through member 94) is fixed to the upper rail 18 by fastening the bolt 102 with a nut. The fixation of the load transmission mechanism 92 (screw-through member 94) to the upper rail 18 is not limited to fastening between the bolt 102 and the nut, and may be implemented by other techniques such as welding.

The front wall 94a of the screw-through member 94 has a concave surface 106a on an inner wall surface 104a. The concave surface 106a can be a curved surface that is recessed frontward Xa (axial direction) to the rotation center M of the rod screw member 22. The concave surface 106a is smoothly processed to be able to smoothly come into sliding contact with the spheres 54 (FIG. 10 shows only one sphere) supported by the front guide member 98a. Similarly, the rear wall 94b includes a concave surface 106b on an inner wall surface 104b. The concave surface 106b can be a curved surface that is recessed rearward Xb (axial direction) to the rotation center M of the rod screw member 22. The concave surface 106b is smoothly processed to be able to smoothly come into sliding contact with the spheres 54 (FIG. 10 shows only one sphere) supported by the rear guide member 98b.

The screw fixing member 96 is a cylindrical member with a through hole through which the rod screw member 22 passes, and includes a female screw 108a to be screwed with the male screw 22b of the rod screw member 22d. The screw fixing member 96 is fixed to part of the rod screw member 22 to rotate together, and is made of metal such as iron, for example. The screw fixing member 96 may be a nut. The female screw 108a may be slightly smaller in diameter than the male screw 22b of the rod screw member 22, for example, so that the screw fixing member 96 is screwed into the male screw 22b by press fitting for fixation. The fixing position of the screw fixing member 96 can be set depending on the position of the male screw 22b. The screw fixing member 96 may be fixed to the rod screw member 22 in a different manner. For example, the female screw 108a of the screw fixing member 96 may have a diameter corresponding to the diameter of the male screw 22b, and they may be fixed by swaging or welding after being screwed together and positioned.

Both end faces (an end face 96a, an end face 96b) of the screw fixing member 96 in the lengthwise direction X are provided with slide grooves 96c circumferentially extending to receive part of the surfaces of the spheres 54 and support the spheres 54 in a rollable manner. Each slide groove 96c has a depth sufficient to receive, for example, ¼ of the diameter of the spheres 54, and a curvature set equivalent to or slightly smaller than the curvature of the spheres 54. Thus, the spheres 54 can smoothly roll in the slide groove 96c.

A front guide member 98a is placed between the front-side (frontward Xa) end face 96a of the screw fixing member 96 and the inner wall surface 104a of the front wall 94a, to support a plurality of (three in FIG. 9) spheres 54. Likewise, a rear guide member 98b is placed between the rear-side (rearward Xb) end face 96b of the screw fixing member 96 and the inner wall surface 104b of the rear wall 94b, to support a plurality of (three in FIG. 9) spheres 54. The front guide member 98a is placed to maintain the intervals among the spheres 54 in the circumferential direction of the rod screw member 22, and be rotatable relative to at least one of the inner wall surface 104a of the screw-through member 94 and the screw fixing member 96.

As illustrated in FIG. 10, the front guide member 98a is, for example, a cup-like member made of resin, and can be situated to cover the end face 96a of the screw fixing member 96. The bottom of the cup of the front guide member 98a is provided with a guide through hole 98c through which the rod screw member 22 passes, and a plurality of sphere receiving holes 98d functioning as holders that hold (guide) the spheres 54. The sphere receiving holes 98d have, for example, a diameter about 70% of the diameter of the spheres 54. The sphere receiving holes 98d receive the spheres 54 from inside the cup and hold the spheres 54 partially protruding toward the concave surface 106a of the front wall 94a so as not to drop out from the front guide member 98a, as illustrated in FIG. 10. In FIG. 9, three sphere receiving holes 98d are formed at, for example, 120-degree intervals corresponding to the number of spheres 54 to guide. The rear guide member 98b has the same structure as the front guide member 98a. Thus, along with the rotation of the screw fixing member 96 and the rod screw member 22, the spheres 54, the front guide member 98a, and the rear guide member 98b freely rotate in the circumferential direction of the rod screw member 22 while the spheres 54 maintain the intervals in the circumferential direction of the rod screw member 22 without being affected by the rotation of the screw fixing member 96. As a result, the spheres 54 roll on the concave surface 106a (concave surface 106b) of the inner wall surface 104a (inner wall surface 104b) of the screw-through member 94 at a low resistance. The screw fixing member 96 rotates together with the rod screw member 22. The screw fixing member 96 moves forward and rearward relative to the nut member 26 in the lengthwise direction X due to the rotation of the rod screw member 22, pushing the front wall 94a or the rear wall 94b of the screw-through member 94 via the rollable spheres 54 to move the screw-through member 94 forward and rearward in the lengthwise direction X. That is, if the rod screw member 22 undulates while rotating, the relative position of the screw-through member 94 and the screw fixing member 96 is smoothly changed, thereby abating variation in the rotational resistance of the rod screw member 22 due to the undulation. Thus, variation in the rotational speed of the rod screw member 22 can be reduced. In this manner, the load transmission mechanism 92 can abate variation in the rotational speed of the undulating rod screw member 22 in rotation, and reduce occurrence of vibration or unusual noise at the time when the upper rail 18 (seat S) is slid.

In the load transmission mechanism 92, the guide member 98 works to maintain the intervals among the spheres 54 in the circumferential direction of the rod screw member 22. Thus, with a less number of spheres 54 disposed, the screw-through member 94 and the screw fixing member 96 can be maintained in parallel in a contact state in the lengthwise direction X. For example, with three or more spheres 54 situated, the screw-through member 94 and the screw fixing member 96 can be supported at at least three points and prevented from tilting at the time of sliding-contact with each other. This results in smooth relative movement of the screw-through member 94 and the screw fixing member 96. In another embodiment, the front guide member 98a may be fixed to or may be integrated with either of the end face 96a of the screw fixing member 96 and the inner wall surface 104a of the front wall 94a. Likewise, the rear guide member 98b may be fixed to or may be integrated with either of the end face 96b of the screw fixing member 96 and the inner wall surface 104b of the rear wall 94b. In this case, the number of types of components can be reduced, which can contribute to reducing design cost, component cost, component management cost, and man-hours for assembly.

If the front and rear end faces 96a and 96b of the screw fixing member 96 and the slide groove 96c have the same shape, the front guide member 98a can double as the rear guide member 98b, or vice versa. The front and back sides of the front guide member 98a doubling as the rear guide member 98b can be simply reversed so as to support the spheres 54 between the screw fixing member 96 and the inner wall surface 104b of the rear wall 94b in a rollable manner.

The concave surface 106a of the inner wall surface 104a of the front wall 94a of the screw-through member 94 and the concave surface 106b of the inner wall surface 104b of the rear wall 94b may be, for example, part of a spherical surface centered on a point H being an intersection point between the rotation axis of the rod screw member 22 and the rotation axis of the bolt 102 of the screw-through member 94. In this case, for example, if, in fixing the load transmission mechanism 92 to the upper rail 18, assembly error (rotation) occurs in the rotation direction of the bolt 102 or the rod screw member 22 undulates while rotating, the rod screw member 22 undulates around the point H. In other words, the screw-through member 94 smoothly rolls together with the screw fixing member 96 via the spheres 54. Consequently, this makes it possible to abate resistance to the rotation of the rod screw member 22 arising from the undulation of the rod screw member 22 due to assembly error or error in dimensional accuracy of the members. That is, variation in the rotational speed of the rod screw member 22 can be reduced, thereby reducing occurrence of vibration or unusual noise at the time when the upper rail 18 (seat S) is slid.

As illustrated in FIG. 10, in the load transmission mechanism 92, the screw-through member 94 has the concave surface 106a on the inner wall surface 104a of the front wall 94a, and the concave surface 106b on the inner wall surface 104b of the rear wall 94b. As described in the first embodiment, irrespective of an excessively large rearward or forward load acting on the screw-through member 94, the spheres 54 can be pressed down toward the rotation center M (axis) of the rod screw member 22. This can prevent an excessively large load on the screw-through member 94 from deforming or damaging the front guide member 98a or the rear guide member 98b and avoid the spheres 54 from falling off (dropping out) from the front guide member 98a or the rear guide member 98b. That is, the load transmission mechanism 92 can have an advantageous structure in terms of strength against forward and rearward loads.

When the sliding contact surfaces (concave surfaces 106a and 106b), which come into sliding contact with the spheres 54, are curved surfaces recessed in the axial direction toward the rotation center M of the rod screw member 22 as illustrated in FIG. 10, the concave surfaces 106a and 106b need to have a curvature smaller than the curvature of the spheres 54. In this case, the spheres 54 can be not in multipoint contact or surface contact but in point contact with the concave surfaces 106a and 106b. As a result, as described above, upon receiving an excessively large load, the concave surfaces 106a and 106b can effectively press the spheres 54 toward the rotation center M of the rod screw member 22, in addition to the effect of the convex surface 62a in point contact as described in the first embodiment, that is, smoothly and stably changing the relative position between the screw-through member 94 and the screw fixing member 96.

The above embodiment has described the example of forming the concave surface 106a on the front wall 94a of the screw-through member 94, and forming the concave surface 106b on the rear wall 94b. However, these surfaces may be flat surfaces. The above embodiment has also described the example of forming the slide grooves 96c in the end face 96a and the end face 96b of the screw fixing member 96, however, these faces may be flat faces. In the case of flat end faces, the spheres 54 as a rolling member may be used, or the cylindrical rollers 54a, described with reference to FIG. 6, may be used in place of the spheres 54, for example. In this case, as with the rollers 54a in the first embodiment, the present embodiment can attain the effects similar to those by using the spheres 54.

The above embodiments have described the example of using the guide member to guide a plurality of (for example, three) roll members (spheres 54 or rollers 54a). However, the number of roll members to guide is changeable when appropriate. A larger number of roll members can more stably come into sliding contact. When a sufficiently large number of roll members are arranged around the rod screw member 22, the guide member may be omissible. In this case, for example, with the roll members disposed in an unbalanced manner in the circumferential direction of the rod screw member 22, the guide member may be omissible as long as the screw-through member 52 (76, 94) and the screw fixing member 50 (74, 96) can be substantially prevented from tilting at the time of sliding contact with each other. Similarly, if the roll members are densely arranged in the circumferential direction but a difference in density does not match or exceed a certain value, the guide member may be omissible.

The respective embodiments have described the guide grooves 68a (90a) or the sphere receiving holes 98d having a width or a diameter sufficient to hold one roll member. In another embodiment, the guide grooves 68a (90a) or the sphere receiving holes 98d can have a wider width in the circumferential direction of the rod screw member 22, allowing the rolling members to move in the circumferential direction so long as the rolling members are not arranged in an excessively unbalanced manner in the circumferential direction of the rod screw member 22. For example, the guide grooves 68a (90a) may be long groves with a wider circumferential width, or the sphere receiving holes 98d may be long holes with a wider circumferential width. In this case, the rollability of the rolling members can be further flexibly set, so that the rolling members become more smoothly rollable while sliding between the screw-through member 52 (76, 94) and the screw fixing member 50 (74, 96).

To hold the rolling members with the guide member 60 (80, 98), a holder having a different shape may be used instead of the guide grooves 68a (90a) and the sphere receiving holes 98d. For example, projections may be provided to hold both circumferential sides of the rolling members to limit their movement. In this case, as with the guide grooves 68a (90a) and the sphere receiving holes 98d, a pair of projections adjacent to each other may be provided to substantially hold the rolling members in-between to restrict the circumferential movement. Alternatively, a pair of projections may be spaced apart from each other at an interval larger than the size of the rolling members so as to allow the rolling members to circumferentially move to a certain extent. To form the guide member 60 (80, 98) of resin, a die or a mold for forming the above holder being the projections can be more simplified than that for forming the guide grooves 68a (90a) or the sphere receiving holes 98d, which can contribute to reducing component cost.

The respective embodiments have described the example of fixing the nut member 26 housed in the nut housing 28 to the lower rail 16 placed on either of the floor F and the seat S, and fixing the rod screw member 22 extending in the lengthwise direction X, the gearbox 32, and the load transmission mechanism 48 (48A, 72, 92) to the upper rail 18 situated on the other of the floor F and the seat S. In another embodiment, the rod screw member 22, the gearbox 32, and the load transmission mechanism 48 (48A, 72, 92) may be fixed to the lower rail 16, while the nut member 26 housed in the nut housing 28 may be fixed to the upper rail 18. This embodiment can attain similar effects. The embodiment has illustrated the power seat slide device 20 including the lower rail 16 and the upper rail 18. In another embodiment, the rod screw member 22, the gearbox 32, and the load transmission mechanism 48 (48A, 72, 92) may be directly fixed to the back surface of the seat S, and the nut member 26 housed in the nut housing 28 may be directly fixed to the floor F. This embodiment can attain similar effects.

The embodiments of the present invention have been illustrated above, however, the embodiments are merely exemplary and not intended to limit the scope of the invention. The present invention can be implemented in various other forms, and various omissions, replacements, combinations, or modifications can be made without departing from the gist of the invention. These various forms or modifications are encompassed by the scope and gist of the invention, and also encompassed by the invention described in the claims and equivalents thereof. Specifications such as configurations and shapes (structure, type, direction, shape, size, length, width, thickness, height, number, arrangement, position, material, and the like) may be changed when appropriate for implementation.

1. A power seat slide device comprising:
a nut member fixed to one of a floor and a seat in a vehicle;
a rod screw member that is placed on the other of the floor and the seat in a lengthwise direction of the vehicle, the rod screw member to be screwed into the nut member;
a screw-through member that is fixed to the other of the floor and the seat, and provided with a through hole through which the rod screw member rotatably passes;
a screw fixing member fixed to part of the rod screw member in an axial direction; and
a plurality of roll members arranged around the rod screw member in a circumferential direction, to come into sliding contact with the screw-through member and the screw fixing member in the axial direction.

2. The power seat slide device according to claim 1, wherein
the roll members are supported by a guide member, the guide member being placed between the screw-through member and the screw fixing member in the lengthwise direction and rotatable relative to at least one of the screw-through member and the screw fixing member.

3. The power seat slide device according to claim 2, wherein
the guide member comprises a holder that maintains an interval between the roll members in the circumferential direction.

4. The power seat slide device according to claim 1, wherein
the screw-through member includes a concave surface serving as a sliding contact surface to come into sliding contact with the rolling members, the concave surface that is recessed in the axial direction toward a rotation center of the rod screw member.

5. The power seat slide device according to claim 1, wherein
the rolling members are spheres, and
the screw-through member includes a convex surface serving as a sliding contact surface to come into sliding contact with the spheres, the convex surface that protrudes in the axial direction toward a rotation center of the rod screw member.

6. The power seat slide device according to claim 1, wherein
the rolling members are spheres,
the screw-through member includes a concave surface serving as a sliding contact surface to come into sliding contact with the spheres, the concave surface that is recessed in the axial direction toward a rotation center of the rod screw member, and
the concave surface is smaller in curvature than the spheres.

7. The power seat slide device according to claim 1, wherein
the number of the roll members is at least three or more.
